(19) United States
(12) Patent Application Publication
(10) Pub. No.: US 2004/0213123 A1
(43) Pub. Date: Oct. 28, 2004

(54) Information memory and reproduction device

(75) Inventors: Toshihiko Takahashi, Osaka (JP); Youichi Ogura, Ehime (JP); Kazutoshi Aida, Osaka (JP)

Correspondence Address: Jack Q. Lever, Jr., McDERMOTT, WILL & EMERY, 600 Thirteenth Street, N.W., Washington, DC, 20005-3096, US

(73) Assignee: Matsushita Electric Industrial Co., Ltd.

(21) Appl. No.: 10/830,107

(22) Filed: Apr. 23, 2004

(30) Foreign Application Priority Data
Apr. 25, 2003 (JP) 2003-121655

(51) Int. Cl. G11B 7/005

(52) U.S. Cl. 369/59.19; 369/59.21; 369/59.15

(57) ABSTRACT

An optical disc device serving as an information memory and reproduction device includes: an A/D converter for performing sampling to an analog signal to convert the analog signal into a first digital signal, which has been offset-adjusted, using an n times higher frequency than that of a channel clock (where n is 2 or a larger integer than 2); and a digital equalizer for digitally performing wave-form equalization of a reproduction signal, which has been converted into the first digital signal, and outputting a second digital signal. In this manner, wave-form equalization is performed to the digital signal which has been A/D converted, so that a small circuit configuration can be obtained. Moreover, oversampling is performed, thus equivalently improving a resolution when A/D conversion is performed.

### BACKGROUND OF THE INVENTION

The present invention relates to equalizers used for information memory devices such as hard disc devices and optical disc devices, and more particularly relates to an information memory and reproduction device which performs A/D conversion of an analog signal and extracts from a digital signal obtained through the conversion a data signal and a clock signal synchronizing with the data signal.

In recent years, the memory density of storage mediums which hard disc devices or optical disc devices deal with has become higher and higher. However, in an information memory device dealing with such a memory medium, when a data signal is recorded at high density, the S/N ratio is reduced and reliability of data is reduced due to interference between codes and crosstalk. Therefore, means for compensating reduction in the reliability caused by deterioration of the quality of the data signal is required.

Conventionally, in an information memory device, when analog signal processing is performed to a reproduction signal (analog signal) output from an optical pickup, frequency-response characteristics of the reproduction signal are influenced by an optical detection system circuit and an electric circuit. In this case, for a reproduction signal having a characteristic in which as the frequency of the reproduction signal is increased, the amplitude of the signal is reduced, the reduction of the amplitude is compensated using an analog equalizer.

An analog equalizer has the characteristic of making a signal component having a desired frequency and, at the same time, has the characteristic of selectively giving a gain to a signal having a predetermined frequency component. Therefore, it is possible to selectively compensate reduction in signal amplitude by adjusting equalization characteristics so as to obtain a desired frequency.

On the other hand, when digital signal processing is performed to a reproduction signal (analog signal), as known methods for compensating reduction in an amplitude of a signal having a high frequency component, the following two methods are used.

A first method is a method in which wave-form equalization is performed to an analog signal by an analog equalizer and then A/D conversion is performed to the wave-form equalized analog signal to obtain a digital signal (See Japanese Patent Publication No. 2517709). A known equalizer which realizes the method will be hereafter described with reference to FIG. 6. As shown in FIG. 6, an analog signal output from an optical pickup 200 is amplified by a variable gain amplifier (VGA) 201 and furthermore is input to an analog low-pass filter (LPF) 202. From the analog signal received by the analog LPF 202, a high frequency component unnecessary for wave-form equalization is removed, and subsequently, wave-form equalization of the analog signal received by the analog LPF 202 is performed by an analog equalizer 203. In this case, equalization characteristics of the analog equalizer 203 are set so as to allow a high frequency component of a signal to pass. Thus, reduction in signal amplitude can be selectively compensated. Subsequently, the wave-form equalized analog signal is received by an A/D converter 205 via an offset control circuit 204 and converted into a digital signal. The A/D converted digital signal is binarized by a binarizer circuit 206 and then is output.

A second method is a method in which a digital equalizer is used, instead of the analog equalizer. In this case, a digital equalizer for performing wave-form equalization to digital signal is provided in the subsequent stage of the A/D converter 205. When the digital equalizer is used, it is necessary to increase the resolution of the A/D converter 205. This is for obtaining sufficient necessary information from a high frequency component with a reduced signal amplitude when A/D conversion of an analog signal having a large amplitude difference is performed. Note that as a method for increasing the resolution of the A/D converter 205, for example, a method for increasing a conversion bit number for A/D conversion is used.

However, in the known methods, when a digital processing of an analog signal is performed in an information memory and reproduction device such as an optical disc device, the following problems or other various problems arise.

First, since the first method uses the analog equalizer 203, a problem arises when an analog signal to be wave-form equalized has a frequency varying with time, as, for example, a reproduction signal to be reproduced in a constant angular velocity (CAV) system. In this case, a control operation for changing equalization characteristics of the analog equalizer 203 according to a frequency of the reproduction signal is necessary. If the accuracy of the control operation is low, equalization error becomes large, thus resulting in deterioration of signal characteristics of the reproduction signal. Moreover, when the control operation for changing equalization characteristics is performed with high accuracy, the control operation itself becomes complicated and a circuit scale is increased.

Furthermore, in the case where the analog equalizer 203 is used, another problem arises when a signal processing device shown in FIG. 6 is realized as a system LSI (large scale integrated circuit). Specifically, when a signal processing device is realized using a system LSI, it is necessary to integrate circuits such as an analog circuit, a digital circuit and a memory circuit, which have been individually formed into an LSI in a known manner, on a chip. In the case of a digital circuit, if a design rule in processes is reduced, a circuit scale is reduced according to a reduction amount of the design rule. Therefore, costs can be also reduced. On the other hand, in the case of an analog circuit, even if the design rule is reduced, the benefit of reduction in a circuit scale is hardly gained. In other words, when being formed into a system LSI (CMOS), an analog circuit occupies a large area, compared to a digital circuit, thus causing increase in costs.

Moreover, as in the second method, when the analog equalizer 203 is not used, and a digital equalizer is used after a signal has been digitalized, to achieve the same performance as that of the analog equalizer 203, per bit resolution of the A/D converter 205 located in the previous stage of the digital equalizer has to be increased. However, as for the A/D converter 205 which is required to operate at high speed, a circuit scale is increased in proportion to a bit number at which A/D conversion is performed. Therefore, when a resolution in performing A/D conversion by increasing a conversion bit number, a problem arises in which a circuit scale is increased. Furthermore, when the circuit scale is increased, a circuit delay is increased, so that a processible signal band is reduced. Accordingly, processing speed is reduced.

### SUMMARY OF THE INVENTION

It is an object of the present invention to solve the above-described, known problems and make it possible to effectively perform wave-form equalization of an analog signal having a large amplitude difference without increasing a circuit scale even when a digital equalizer is used.

To achieve the above described object, according to the present invention, an information memory and reproduction device is formed to have not only a configuration in which after an output signal from an optical pickup has been converted into a digital signal without passing the output signal through an analog equalizer, a digital signal obtained through the conversion is passed through a digital equalizer, but also have a configuration in which when D/A conversion is performed, a clock signal is extracted from a digital signal obtained through the conversion and oversampling is performed using an n times higher frequency than that of an extracted signal (where n is 2 or a larger integer than 2).

Specifically, an information memory and reproduction device according to the present invention includes: a variable gain amplifier for amplifying an input analog signal to a predetermined amplitude level and outputting the amplified analog signal; a low-pass filter for removing a noise component of the amplified analog signal; an A/D convert for converting the analog signal output from the low-pass filter into a first digital signal and outputting the first digital signal; a digital equalizer for performing wave-form equalization to the first digital signal and outputting a second digital signal; an amplitude information detection circuit for detecting amplitude information from the first digital signal, generating control information from the detected amplitude information and outputting the control information to the variable gain amplifier; a clock extraction circuit for extracting a synchronous clock signal from the second digital signal and outputting the extracted clock signal to the A/D converter and the digital equalizer; and a frequency divider for dividing an output from the clock extraction circuit and outputting the divided output. In the information memory and reproduction device, the clock extraction circuit outputs to the A/D converter a sampling clock signal having an n times higher frequency than a frequency which defines a channel clock (where n is 2 or a larger integer than 2), and the A/D converter performs oversampling by the input sampling clock signal.

The information memory and reproduction device of the present invention includes the digital equalizer for performing wave-form equalization to the first digital signal output from the A/D converter. Thus, the circuit scale of an analog circuit section for performing analog signal processing can be reduced. Moreover, the clock extraction circuit outputs to the A/D converter a sampling clock signal having an n times higher frequency than a frequency defining a channel clock and the A/D converter performs oversampling by a sampling clock signal having the n times higher frequency. Thus, the resolution of A/D converter can be equivalently improved. Accordingly, for a digital signal processed by the digital equalizer, accuracy of wave-form equalization is increased according to a value for a sampling ratio in oversampling. Therefore, with a reduced circuit scale of the analog circuit section, electrical characteristics of the reproduced second digital signal can be improved.

It is preferable that the information memory and reproduction device further includes a data phase comparator for selecting one of n different sampling values contained in the second digital signal and outputting a selected sampling value to the clock extraction circuit. Thus, the clock extraction circuit uses data selected from the n different sampling values by the data phase comparator when a synchronous clock signal is extracted from the second digital signal, i.e., a wave-form equalized data signal. Therefore, for example, if a sampling value which allows reduction in an acquisition time of the synchronous clock, quality of a reproduction signal can be increased.

Moreover, it is preferable that the information memory and reproduction device of the present invention further includes a moving average value operational unit for selecting adjacent two of n different sampling values contained in the second digital signal, performing an operation to selected two sampling values to obtain a moving average, and outputting a sampling value as an operation result to the clock extraction circuit.

Moreover, it is preferable that the information memory and reproduction device of the present invention further includes a moving average value operational unit for selecting at least two of n different sampling values contained in the second digital signal, performing an operation to selected at least two sampling values to obtain a moving average, and outputting a sampling value as an operation result to the clock extraction circuit.

Moreover, it is preferable that the information memory and reproduction device of the present invention further includes a sampling value operational unit for selecting at least two of n different sampling values contained in the second digital signal, performing an addition operation, a subtraction operation or an interpolation operation to selected at least two sampling values, and outputting a sampling value as an operation result to the clock extraction circuit.

Moreover, it is preferable that the information memory and reproduction device of the present invention further includes a filter for removing an unnecessary signal component from an output signal from the sampling value operational unit, the filter being provided between the sampling value operational unit and the clock extraction circuit.

It is preferable that the information memory and reproduction device of the present invention further includes a downsampling circuit for changing a frequency of the second digital signal back to the frequency which defines a channel rate. Thus, a digital signal output from the downsampling circuit is changed back to a normal channel rate (data rate), so that the digital circuit provided in the subsequent stage can perform signal processing at the normal channel rate.

Moreover, it is preferable that the information memory and reproduction device of the present invention further includes an offset control circuit for adjusting a shift from a center axis of an amplitude of the analog signal so that the analog signal is located within a dynamic range of the A/D converter, the offset control circuit being provided in a previous stage of the A/D converter.

In this case, it is preferable that the information memory and reproduction device of the present invention further includes an offset detection circuit for detecting an offset of an input analog signal from the first digital signal and outputting a value for a detected offset to the offset control circuit; an operational circuit for improving reliability of the second digital signal; and a binarizer circuit for performing binarization to the second digital signal.

It is preferable that in the information memory and reproduction device the present invention, the clock extraction circuit includes a voltage control oscillator.

Moreover, is preferable that in the information memory and reproduction device the present invention, the clock extraction circuit includes a phase synchronous loop circuit.

### BRIEF DESCRIPTION OF THE DRAWINGS

FIG. 1 is a block diagram of major part including a wave-form equalizing section in an information memory and reproduction device according an embodiment of the present invention.

FIGS. 2A and 2B illustrate the operation of an amplitude information detection circuit in an information memory and reproduction device of the embodiment of the embodiment:

FIG. 2A is a graph showing a signal amplitude when an amplitude information detection circuit is not in an operation state; and FIG. 2B is a graph showing a signal amplitude when the amplitude information detection circuit is in an operation state.

FIGS. 3A and 3B illustrate the operation of an offset control circuit in information memory and reproduction device of the embodiment of the present invention:

FIG. 3A is a graph showing a signal before being received by the offset control circuit; and FIG. 3B is a graph showing a signal after being received by the offset control circuit.

FIG. 4 is a block diagram illustrating a digital circuit section of a wave-form equalizing section in an information memory and reproduction device according to a first modified example of the embodiment of the present invention.

FIG. 5 is a timing chart illustrating the operation of the wave-form equalizing section of the wave-form equalizing section in the information memory and reproduction device of the first modified example.

FIG. 6 is a block diagram of major part including a wave-form equalizing section in a known optical disc device.

### DESCRIPTION OF THE PREFERRED EMBODIMENTS

Embodiments of the present invention will be described with reference to the accompanying drawings.

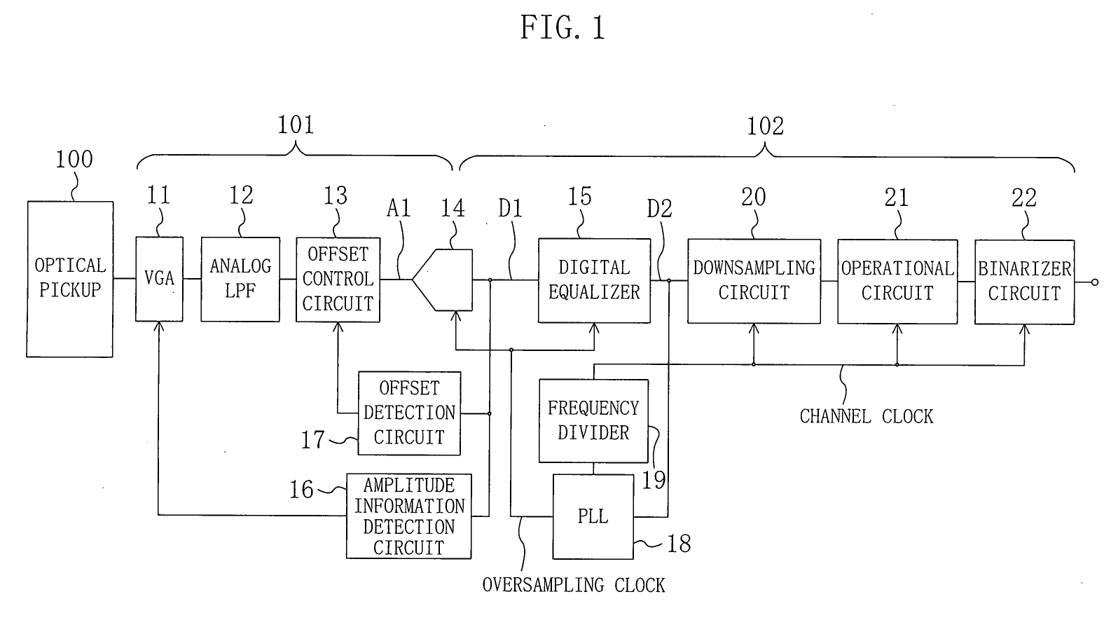

FIG. 1 is a block diagram of major part including a wave-form equalizing section in an optical disc device which is an information memory and reproduction device according an embodiment of the present invention.

As shown in FIG. 1, the optical disc device of this embodiment includes a variable gain amplifier (VGA) 11 for dynamically amplifying a weak signal output from an optical pickup 100 to a predetermined amplitude level; an analog low-pass filter 12 for removing a high frequency noise component from the analog signal amplified to the predetermined amplitude level; an offset control circuit 13 for adjusting a shift (offset) from the center axis of an amplitude of the analog signal so that the analog signal is located within a dynamic range of an A/D converter 14 in the subsequent stage; the A/D converter 14 for performing oversampling to an analog signal A1 which has been offset-adjusted at a frequency n times higher than that of a channel clock (where n is 2 or a larger integer, and this condition will be used hereafter) to convert the analog signal A1 into a first digital signal D1 and outputting the first digital signal; a digital equalizer 15 for digitally performing a wave-form equalization of the reproduction signal which has been converted into the first digital signal D1 and outputting a second digital signal D2; an amplitude information detection circuit 16 for detecting amplitude information from the first digital signal D1, generating control information for the VGA 11 from the detected amplitude information, and outputting the control information to the VGA 16; an offset detection circuit 17 for detecting an offset amount of the first digital signal D1 to control the offset control circuit 13; a PLL (phase-locked loop) circuit 18 as a clock extraction circuit for extracting a synchronous system clock signal for A/D conversion form the second digital signal D2 and outputting the extracted system clock signal to the A/D converter 14 and the digital equalizer 15; a frequency divider 19 for dividing a frequency of the second digital signal D2 generated by the PLL circuit 18 to obtain a channel clock; a downsampling circuit 20 for performing so-called “downsampling” for changing the frequency of the oversampled second digital signal D2 back to a frequency (i.e., channel rate) for defining a channel clock; an adaptive filter for compensating, using as an input signal a signal output from, for example, the downsampling circuit 20 which improves reliability of the second digital signal D2, a strain of the input signal, or an operational circuit 21 for performing Viterbi decoding using PRML (partial response maximum likelihood); and a binarizer circuit 22 for binarizing the input analog signal which is to be output from this device.

Note that the channel clock is a clock signal used for synchronization of a reproduced digital signal (data signal) and the system clock is a clock signal used for oversampling in performing A/D conversion.

Moreover, the clock extraction circuit, i.e., a clock recovery circuit, is not limited to the PLL circuit, but a voltage controlled oscillator (VCO) including a frequency comparator and a phase comparator may be used. Moreover, a value for the oversampling ratio is preferably a multiple of 2, and furthermore, the value is more preferable a power of 2 (i.e., 2ⁿ).

Moreover, in this case, part of the optical disc device from the VGA 11 to the A/D converter 14 is called an “analog circuit section 101” and part thereof from the digital equalizer 15 to the binarizer circuit 22 is called a “digital circuit section 102”.

Hereafter, the operation of the optical disc device having the above-described structure will be described.

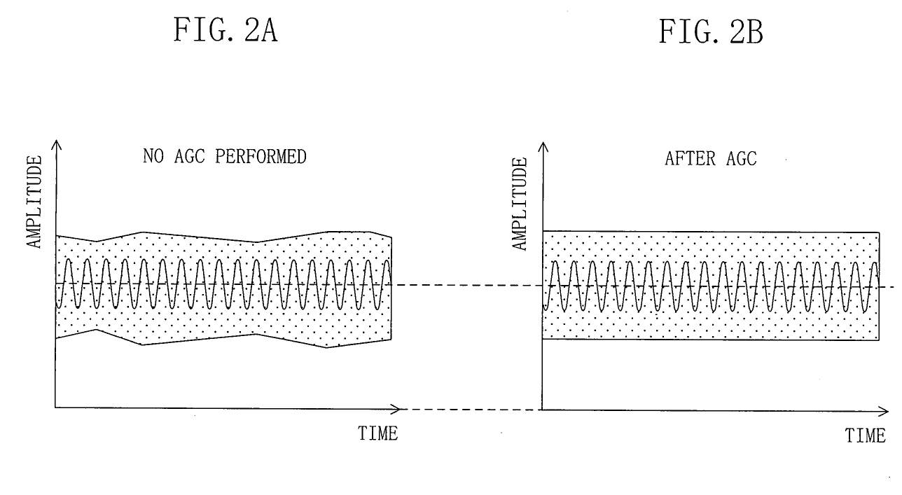

First, the optical pickup 100 irradiates read light (laser beam) to a recording surface of an optical disc (not shown) on which desired data is recorded, converts reflected light from the optical disc into an electric signal (analog signal) and then outputs the electric signal. In this case, the analog signal output from the optical pickup 100 is weak. Moreover, a variation in the amplitude of the analog signal as shown in FIG. 2A is caused, depending on various properties of a servo circuit for controlling an optical disc or a recording data region recorded onto the optical disc, and a focus position of a laser beam. When an analog signal with such a variation is received by the VGA 11, in the VGA 11, the input analog signal has a constant amplitude as shown in FIG. 2B due to the automatic gain control (AGC) function of a control signal which is output from the amplitude information detection circuit 16 and of which the amplitude (output value) varies according to the input signal.

Next, the analog signal having a constant amplitude due to the VGA 11 is received by the analog low-pass filter (LPF) 12. The analog LPF 12 reduces noise which may be a factor for inhibiting processing in a signal processing section in the subsequent stage and is located in the outside of a signal band and, at the same time, t, a high frequency component of the input analog signal is removed o prevent a folding strain generated in the A/D converter 14.

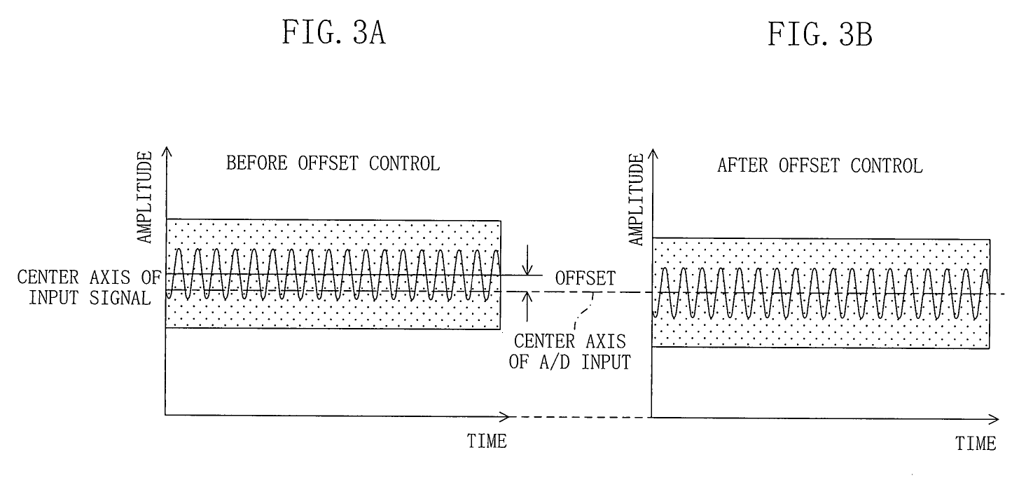

Next, the analog signal from which the high frequency component has been removed by the analog LPF 12 is received by the offset control circuit 13. Even if the center axis of the amplitude of the input analog signal is shifted, as shown in FIG. 3A, the offset control circuit 13 removes an offset so that the analog signal is located within a dynamic range of the A/D converter 14, as shown in FIG. 3B.

Next, the analog signal with an amplitude in which a shift of the center axis is corrected by the offset control circuit 13 is received by the A/D converter 14. In this case, the A/D converter 14 converts the analog signal into a first digital signal D1 by so-called oversampling using a sampling clock having an n times higher frequency than that of a channel clock which defines a channel rate and is to be output from the PLL circuit 18.

Next, the converted first digital signal D1 oversampled by the A/D converter 14 using the sampling clock having the n times higher frequency than the channel rate is received by the digital equalizer 15, subjected to wave-form equalization, and then output as a second digital signal D2. In the digital equalizer 15, the input first digital signal D1 is ovesampled, so that wave-form equalization can be performed with accuracy corresponding a value n for an oversampling rate, compared to the case where a digital signal sampled using the channel rate is subjected to wave-form equalization. Accordingly, the same performance as that in the case where the known analog equalizer is used can be obtained. Moreover, a frequency at which a folding strain is generated becomes n times higher, so that a performance required for the analog LPF 12 can be relaxed.

At the same time, the first digital signal D1 converted by the A/D converter 14 is received by the amplitude information detection circuit 16 and the offset detection circuit 17 in parallel. The amplitude detection circuit 16 monitors the amplitude of the first digital signal D1 and controls a gain in the VGA 11 so that the amplitude of the first digital signal D1 has a constant amplitude value. Moreover, the offset detection circuit 17 detects an offset amount of the input first digital signal D1 and outputs the detected offset amount to the offset control circuit 13.

Next, the second digital signal D2 output from the digital equalizer 15 is received by the PLL circuit 18. The PLL circuit 18 extracts a synchronous system clock (oversampling clock) signal from the second digital signal D2 and outputs the extracted system clock signal to the A/D converter 14 and the digital equalizer 15. Note that although not shown in FIG. 1, the PLL circuit 18 includes a frequency comparator, a phase comparator and a loop filter. Note that the PLL circuit 18 is capable of outputting a signal having a higher frequency than that of a system clock signal.

The frequency divider 19 divides a frequency of a system clock signal output from the PLL circuit 18 to convert the system clock signal to a channel clock. Then, the frequency divider 19 supplies the channel clock obtained through the conversion to the downsampling circuit 20, the operational circuit 21 and the binarizer circuit 22, respectively. Note that the frequency divider 19 is capable of outputting a signal having a lower frequency than that of the channel clock.

Next, the second digital signal D2 output from the digital equalizer 15 is received by the downsampling circuit 20 in the subsequent stage and then the frequency is changed back to a frequency defining a channel rate. That is, so-called downsampling is performed.

Subsequently, the downsampled second digital signal D2 to the channel rate is received by the operational circuit 21 and the binarizer circuit 22 in the subsequent stage in this order.

Note that the operational circuit 21 in the subsequent stage of the downsampling circuit 20 is not necessarily provided.

As has been described, in the optical disc device of this embodiment, no anolog equalizer is provided in the analog circuit section 101 but the digital equalizer 15 is provided in the digital circuit section 101, instead. Thus, the circuit scale of the analog circuit section 101 can be reduced and also power consumption can be reduced.

Furthermore, the A/D converter 14 performs n times higher oversampling to convert the first digital signal D1. Thus, wave-form equalization to the first digital signal D1 obtained through the oversampling can be performed with high accuracy according to the value n for an oversampling rate. As a result, a weak analog signal output from the optical pickup 100 can be converted into a digital signal with high accuracy while a circuit scale is reduced.

### FIRST MODIFIED EXAMPLE

Hereafter, a first modified example of the above-described embodiment of the present invention will be described with reference to the drawings.

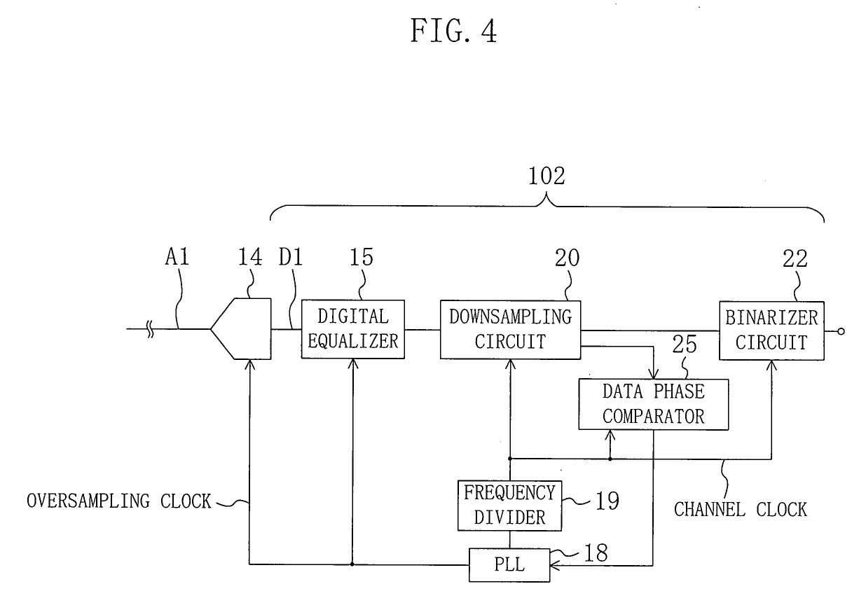

FIG. 4 is a block diagram illustrating the configuration of a digital circuit section including a digital equalizer in an optical disc device according to a first modified example of the embodiment of the present invention. In FIG. 4, each member also shown in FIG. 1 is identified by the same reference numeral and therefore description thereof is omitted. Moreover, the optical disc device is formed to have a configuration in which the operational circuit 21 is not provided.

As shown in FIG. 4, in the digital circuit section 102 of the first modified example, a data phase comparator 25 for receiving a digital signal output from the downsampling circuit 20 and a channel clock signal output from the frequency divider 19, selecting one of n different sampling values contained in a second digital signal D2 and outputting a selected sampling value to the PLL circuit 18 is provided.

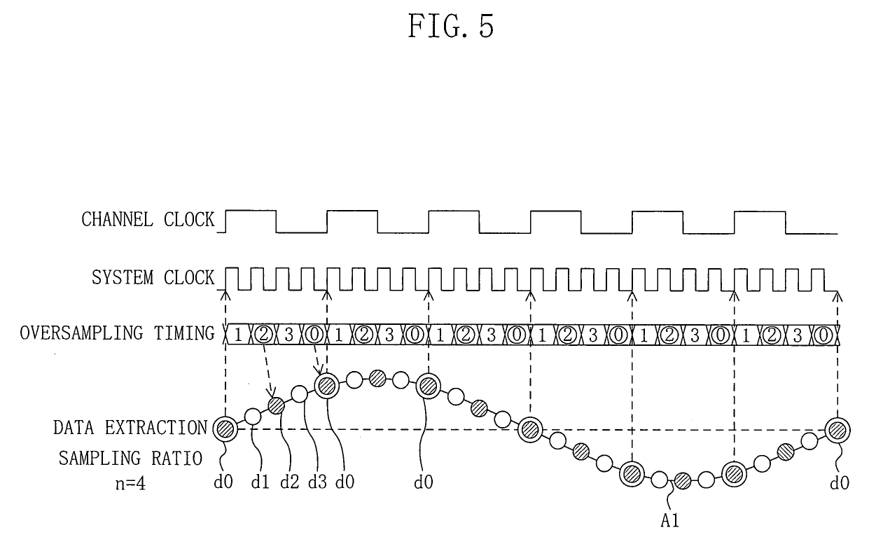

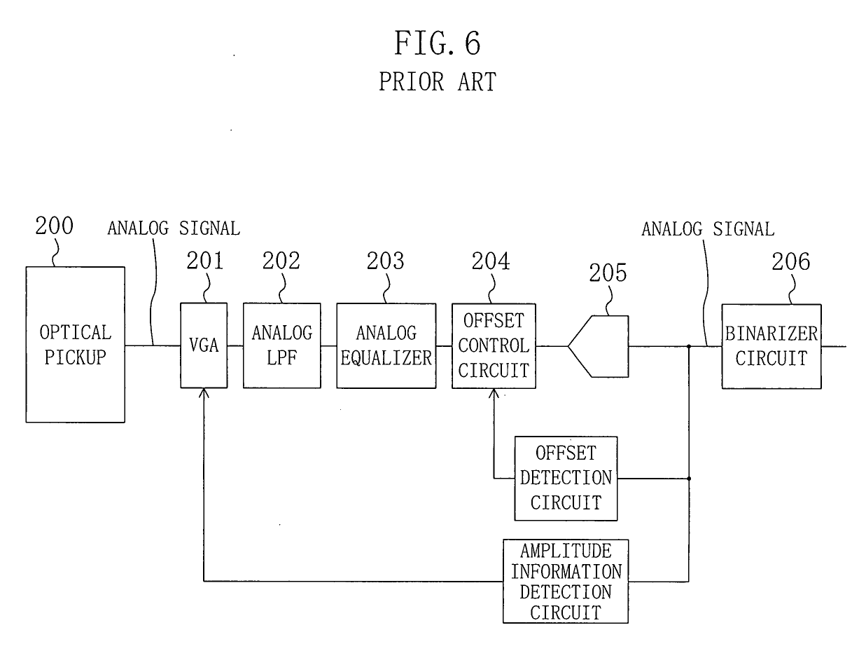

Now, the operation of the data phase comparator 25 will be described with reference to FIG. 5.

As shown in FIG. 5, in the first modified example, for example, a system clock has a four times higher frequency than that of a channel clock, i.e., a synchronous signal when a reproduction signal (data signal) to be output to the outside is dealt with. That is, the value for sampling ratio n when A/D conversion is performed is set to be 4. The reference numerals d0, d1, d2 and d3 denote sampling values (digital signal) obtained from an input analog signal A1 through conversion. In the case of the known device in which oversampling is not performed, by the way, only d0 is a sampling value to the analog signal A1.

When the data phase comparator 25 selects any one of these four sampling values d0 through d3, data can be reproduced. A preferable selection condition is that, for example, with the sampling value d2 set to be a reference value, a signal can be extracted for each of the four samples to perform processing.

### SECOND MODIFIED EXAMPLE

Next, in a second modified example of the embodiment, a moving average value operational unit is provided, instead of the data phase comparator 25. The moving average value operational unit of the second modified example selects adjacent two of the four different sampling values d0 through d3 for each channel clock contained in the second digital signal D2, performs an operation (e.g., (d0+d1)/2) to obtain a moving average value for the selected two sampling values, and outputs the operation result to the PLL circuit 18. Thus, a resolution when A/D conversion is performed can be improved.

### THIRD MODIFIED EXAMPLE

Next, in a third modified example, a moving average value operational unit is provided, instead of the data phase comparator 25. The moving average value operational unit of the third modified example selects at least two of the four different sampling values d0 through d3 for each of channel clock contained in the second digital signal D2, performs an operation (e.g., (d0+d1+d2)/3) to obtain a moving average value for the selected at least two sampling values, and outputs the operation result to the PLL circuit 18. Thus, a resolution when A/D conversion is performed can be improved.

### FOURTH MODIFIED EXAMPLE

Next, in a fourth modified embodiment, a sampling value operational unit is provided, instead of the data phase comparator 25. The sampling value operational unit of the fourth modified example selects at least two of the four different sampling values d0 through d3 for each channel clock contained in the second digital signal D2, performs an addition operation, a subtraction operation, or an interpolation operation for the selected at least two sampling values, and outputs the operation result to the PLL circuit 18.

Furthermore, in this case, it is preferable to provide a filter for removing an unnecessary signal component from an output signal from the sampling value operational unit between the sampling value operational unit and the PLL circuit 18.

What is claimed is:

1. An information memory and reproduction device comprising:
a variable gain amplifier for amplifying an input analog signal to a predetermined amplitude level and outputting the amplified analog signal;
a low-pass filter for removing a noise component of the amplified analog signal;
an A/D convert for converting the analog signal output from the low-pass filter into a first digital signal and outputting the first digital signal;
a digital equalizer for performing wave-form equalization to the first digital signal and outputting a second digital signal;
an amplitude information detection circuit for detecting amplitude information from the first digital signal, generating control information from the detected amplitude information and outputting the control information to the variable gain amplifier;
a clock extraction circuit for extracting a synchronous clock signal from the second digital signal and outputting the extracted clock signal to the A/D converter and the digital equalizer; and
a frequency divider for dividing an output from the clock extraction circuit and outputting the divided output,
wherein the clock extraction circuit outputs to the A/D converter a sampling clock signal having an n times higher frequency than a frequency which defines a channel clock (where n is 2 or a larger integer than 2), and
wherein the A/D converter performs oversampling by the input sampling clock signal.

2. The information memory and reproduction device of claim 1, further comprising a data phase comparator for selecting one of n different sampling values contained in the second digital signal and outputting a selected sampling value to the clock extraction circuit.

3. The information memory and reproduction device of claim 1, further comprising a moving average value operational unit for selecting adjacent two of n different sampling values contained in the second digital signal, performing an operation to selected two sampling values to obtain a moving average, and outputting a sampling value as an operation result to the clock extraction circuit.

4. The information memory and reproduction device of claim 1, further comprising a moving average value operational unit for selecting at least two of n different sampling values contained in the second digital signal, performing an operation to selected at least two sampling values to obtain a moving average, and outputting a sampling value as an operation result to the clock extraction circuit.

5. The information memory and reproduction device of claim 1, further comprising a sampling value operational unit for selecting at least two of n different sampling values contained in the second digital signal, performing an addition operation, a subtraction operation or an interpolation operation to selected at least two sampling values, and outputting a sampling value as an operation result to the clock extraction circuit.

6. The information memory and reproduction device of claim 1, further comprising a filter for removing an unnecessary signal component from an output signal from the sampling value operational unit, the filter being provided between the sampling value operational unit and the clock extraction circuit.

7. The information memory and reproduction device of claim 1, further comprising a downsampling circuit for changing a frequency of the second digital signal back to the frequency which defined a channel rate.

8. The information memory and reproduction device of claim 1, further comprising an offset control circuit for adjusting a shift from a center axis of an amplitude of the analog signal so that the analog signal is located within a dynamic range of the A/D converter, the offset control circuit being provided in a previous stage of the A/D converter.

9. The information memory and reproduction device of claim 8, further comprising:
an offset detection circuit for detecting an offset of an input analog signal from the first digital signal and outputting a value for a detected offset to the offset control circuit;
an operational circuit for improving reliability of the second digital signal; and
a binarizer circuit for performing binarization to the second digital signal.

10. The information memory and reproduction device of claim 1, wherein the clock extraction circuit includes a voltage control oscillator.

11. The information memory and reproduction device of claim 1, wherein the clock extraction circuit includes a phase synchronous loop circuit.
